(19) United States
(12) Patent Application Publication
(10) Pub. No.: US 2026/0205586 A1
(43) Pub. Date: Jul. 16, 2026

(54) Multi-Tree Recursive Partitioning Schemes for Image and Video Compression

(71) Applicant: Google LLC, Mountain View, CA (US)

(72) Inventors: Debargha Mukherjee, Cupertino, CA (US); Yue Chen, Kirkland, WA (US); Xiang Li, Saratoga, CA (US); Urvang Joshi, Mountain View, CA (US); Jianle Chen, San Diego, CA (US); Chi Yo Tsai, San Francisco, CA (US)

(21) Appl. No.: 19/134,501

(22) PCT Filed: Dec. 11, 2023
(86) PCT No.: PCT/US2023/083458

§ 371 Date: May 30, 2025

Related U.S. Application Data
(60) Provisional application No. 63/431,579, filed on Dec. 9, 2022.

(51) Int. Cl. H04N 19/119; H04N 19/176; H04N 19/96

(52) U.S. Cl. CPC H04N 19/119; H04N 19/176; H04N 19/96

(57) ABSTRACT

Encoding and decoding uses a multi-tree partitioning scheme comprising multiple categories (trees). Each category has a set of block split-type options such that each resultant sub-partition in each available block split-type option also belongs to one of the multiple categories. A category of the multi-tree recursive partitioning scheme is identified, and a block is partitioned using a split-type option belonging to the category of the multi-tree recursive partitioning scheme. The partitioning scheme is a recursive partitioning scheme, and the resulting sub-blocks may be encoded and subsequently decoded. Each category of the multi-tree recursive partitioning scheme may be defined by a unique, unordered pair (p, q) of block sizes p*2^{m}×q*2ⁿ, p and q are odd, positive integers, and m and n are positive integers.

### BACKGROUND

Digital images and video can be used, for example, on the internet, for remote business meetings via video conferencing, high-definition video entertainment, video advertisements, or sharing of user-generated content. Due to the large amount of data involved in transferring and processing image and video data, high-performance compression may be advantageous for transmission and storage. Accordingly, it would be advantageous to provide high-resolution images and video transmitted over communications channels having limited bandwidth, such as image and video coding using inter-intra prediction with implicit models.

### SUMMARY

This application relates to encoding and decoding of images, video streams, or both, for transmission or storage. Disclosed herein are aspects of systems, methods, and apparatuses for encoding and decoding image data using multi-tree recursive schemes that can be used with recursive block partitioning of blocks with power-of-two and non-power-of-two sizes that facilitate power-of-two sizes for prediction and transform.

An aspect of the teachings herein is a method for decoding image data (e.g., from a still image or a frame). The method can include identifying, from an encoded bitstream, a current block to be decoded, identifying block dimensions of the current block, identifying a category of a multi-tree recursive partitioning scheme using the block dimensions, wherein each category of the multi-tree recursive partitioning scheme is defined by a unique, unordered pair (p, q) of block sizes p*2\hat{ }m×q*2\hat{ }n, p and q are odd, positive integers, and m and n are positive integers, identifying a split-type for the current block from available split-types of the category, and decoding one or more sub-blocks of the current block resulting from the split-type.

Another method can include identifying, from an encoded bitstream, a current block to be decoded, identifying block dimensions of the current block, wherein the current block was partitioned using a multi-tree recursive partitioning scheme comprising multiple categories, and each category has a set of block split-type options such that each resultant sub-partition in each available block split-type option also belongs to one of the multiple categories, and decoding the one or more sub-blocks of the current block resulting from a split-type belonging to a category of the multi-tree recursive partitioning scheme that corresponds to the block dimensions.

Another method can include identifying, from an encoded bitstream, a current block to be decoded, identifying block dimensions of the current block, wherein the current block was partitioned using a multi-tree recursive partitioning scheme comprising multiple categories, and each category has a set of block split-type options for a block size such that no sub-partition of a block within a category of the multiple categories produces a block size that is different from a category of the multiple categories, and decoding one or more sub-blocks of the current block determined using a split-type belonging to a category of the multi-tree recursive partitioning scheme that corresponds to the block dimensions.

Encoding methods corresponding to the decoding methods are also described.

Another method can include identifying a category of a multi-tree recursive partitioning scheme used for encoding a current block, wherein the multi-tree recursive partitioning scheme comprises multiple categories, each category has a set of block split-type options such that each resultant sub-partition in each available block split-type option also belongs to one of the multiple categories, and the category corresponds to block dimensions of the current block, and decoding one or more sub-blocks of the current block resulting from partitioning the current block using a split-type option belonging to the category of the multi-tree recursive partitioning scheme.

Another method can include identifying a category of a multi-tree recursive partitioning scheme for encoding a current block, wherein the multi-tree recursive partitioning scheme comprises multiple categories, each category has a set of block split-type options such that each resultant sub-partition in each available block split-type option also belongs to one of the multiple categories, and the category corresponds to block dimensions of the current block, and encoding one or more sub-blocks of the current block resulting from partitioning the current block using a split-type option belonging to the category of the multi-tree recursive partitioning scheme.

An apparatus described herein includes a processor configured to perform the method according to any one of the above method claims.

Another apparatus described herein includes a processor, and a memory storing instructions that, when executed, cause the processor to perform the method according to any one of the above method claims.

Implementations of a non-transitory computer-readable storage medium storing an encoded bitstream are described herein. In an implementation, the encoded bitstream includes the current block encoded according to the method of any one of the above encoding claims and an identifier of the split-type option. In another implementation, the encoded bitstream includes the current block and an identifier of the split-type option, wherein the encoded bitstream is configured for decoding by the method of any one of the above decoding claims.

In each of the aspects described above, each category of a multi-tree recursive partitioning scheme may be defined by a unique, unordered pair (p, q) of block sizes p*2^{m}×q*2ⁿ, p and q are odd, positive integers, and m and n are positive integers. In some implementations, a first category of the multi-tree recursive partitioning scheme is defined by a first unordered pair (1,1), and a second category of the multi-tree recursive partitioning scheme is defined by a second unordered pair (1,3). In some implementations, a first category of the multi-tree recursive partitioning scheme is defined by a first unordered pair (1,1), a second category of the multi-tree recursive partitioning scheme is defined by a second unordered pair (1,3), and a third category of the multi-tree recursive partitioning scheme is defined by a third unordered pair (1,2). In some implementations, a first category of the multi-tree recursive partitioning scheme is defined by a first unordered pair (1,1), a second category of the multi-tree recursive partitioning scheme is defined by a second unordered pair (1,3), and a third category of the multi-tree recursive partitioning scheme is defined by a third unordered pair (1,5). In some implementations, the multi-tree recursive partitioning scheme comprises two categories, and each set of block split-type options includes at least four split-type options in addition to a no-split option. In some implementations, the multi-tree recursive partitioning scheme comprises three categories, and each set of block split-type options includes at least two split-type options in addition to a no-split option.

In each of the aspects described above, a multi-tree recursive partitioning scheme comprises only binary split-type options and ternary split-type options. In each of the aspects described above, a multi-tree recursive partitioning scheme comprises only binary split-type options in addition to a no-split option. In each of the aspects described above, a multi-tree recursive partitioning scheme comprises only quad split-type options in addition to a no-split option.

Variations in these and other aspects will be described in additional detail hereafter.

### BRIEF DESCRIPTION OF THE DRAWINGS

The description herein makes reference to the accompanying drawings wherein like reference numerals refer to like parts throughout the several views unless otherwise noted or otherwise clear from context.

FIG. 1 is a diagram of a computing device in accordance with implementations of this disclosure.

FIG. 2 is a diagram of a computing and communications system in accordance with implementations of this disclosure.

FIG. 3 is a diagram of a video stream for use in encoding and decoding in accordance with implementations of this disclosure.

FIG. 4 is a block diagram of an encoder in accordance with implementations of this disclosure.

FIG. 5 is a block diagram of a decoder in accordance with implementations of this disclosure.

FIG. 6 is a block diagram of a representation of a portion of an image or frame explaining coding using recursive block partitioning.

FIGS. 7A and 7B are diagrams of a multi-tree partitioning scheme using two categories in accordance with this disclosure.

FIGS. 8A, 8B, and 8C are diagrams of a multi-tree partitioning scheme using three categories in accordance with this disclosure.

FIGS. 9A, 9B, and 9C are diagrams of another multi-tree partitioning scheme using three categories in accordance with this disclosure.

FIGS. 10A, 10B, and 10C are diagrams of yet another multi-tree partitioning scheme using three categories in accordance with this disclosure.

FIGS. 11A and 11B are diagrams of another multi-tree partitioning scheme using two categories in accordance with this disclosure.

FIG. 12 is a flowchart diagram of an example of coding using multi-tree recursive partitioning schemes in accordance with implementations of this disclosure.

FIG. 13 is a diagram showing one example of how to address prediction and transformation for blocks not having power-of-two width and height dimensions.

### DETAILED DESCRIPTION

Image and video compression schemes may include breaking an image, or frame, into smaller portions, such as blocks, and generating an output bitstream using techniques to minimize the bandwidth utilization of the information included for each block in the output. In some implementations, the information included for each block in the output may be limited by reducing spatial redundancy, reducing temporal redundancy, or a combination thereof. For example, temporal or spatial redundancies may be reduced by predicting a frame, or a portion thereof, based on information available to both the encoder and decoder, and including information representing a difference, or residual, between the predicted frame and the original frame in the encoded bitstream. The residual information may be further compressed by transforming the residual information into transform coefficients, quantizing the transform coefficients, and entropy coding the quantized transform coefficients. Other coding information, such as motion information, may be included in the encoded bitstream, which may include transmitting differential information based on predictions of the encoding information, which may be entropy coded to further reduce the corresponding bandwidth utilization. An encoded bitstream can be decoded to reconstruct the blocks and the source images from the limited information. In some implementations, the accuracy, efficiency, or both, of coding a block using either inter-prediction or intra-prediction may be limited. When the image data or information comprises an image instead of a video frame, inter-prediction is not used.

Splitting or breaking the image data into blocks for coding may be performed using a recursive block partitioning scheme. Efficient block partitioning is a major contributor to the performance of a codec. For example, breaking a larger block into blocks with consistent image data can provide for better prediction of the blocks. However, practical reasons often result in a preference to use only power-of-two block sizes for prediction and transformation. The blocks resulting from current partitioning schemes designed to defer to this preference may not represent the most efficient partition of the block. That is, the most common partitioning schemes use blocks with dimensions that are only powers of two (e.g., 2ⁿ×2^{m}, where n and m are positive integers). Blocks with other than power-of-two dimensions may be used in a partitioning scheme, but such a scheme would have to limit those blocks to specific configurations to reduce conflicts (e.g., tree-entanglement conditions) with partitioning of power-of-two blocks.

The multi-tree recursive partitioning schemes described herein provide a framework for recursive block partitioning where power-of-two and non-power-of-two blocks can coexist, e.g., without limiting the partitions to specific configurations. The resulting end or terminal block(s) (e.g., the block(s) resulting from an original block that are no longer partitioned) may be processed in power-of-two sizes for prediction and transformation. Implementations of these teachings are described below after an initial description of the environment in which the teachings may be implemented.

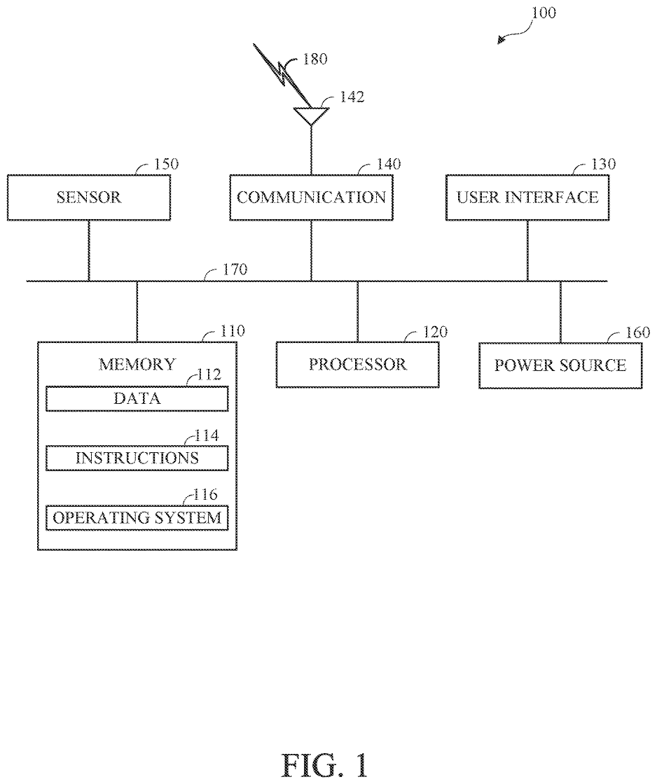

FIG. 1 is a diagram of a computing device 100 in accordance with implementations of this disclosure. The computing device 100 shown includes a memory 110, a processor 120, a user interface (UI) 130, an electronic communication unit 140, a sensor 150, a power source 160, and a bus 170. As used herein, the term “computing device” includes any unit, or a combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one element or elements of the computing device 100 can be integrated into any number of separate physical units. For example, the user interface 130 and processor 120 can be integrated in a first physical unit and the memory 110 can be integrated in a second physical unit.

The memory 110 can include any non-transitory computer-usable or computer-readable medium, such as any tangible device that can, for example, contain, store, communicate, or transport data 112, instructions 114, an operating system 116, or any information associated therewith, for use by or in connection with other components of the computing device 100. The non-transitory computer-usable or computer-readable medium can be, for example, a solid state drive, a memory card, removable media, a read-only memory (ROM), a random-access memory (RAM), any type of disk including a hard disk, a floppy disk, an optical disk, a magnetic or optical card, an application-specific integrated circuits (ASICs), or any type of non-transitory media suitable for storing electronic information, or any combination thereof.

Although shown a single unit, the memory 110 may include multiple physical units, such as one or more primary memory units, such as random-access memory units, one or more secondary data storage units, such as disks, or a combination thereof. For example, the data 112, or a portion thereof, the instructions 114, or a portion thereof, or both, may be stored in a secondary storage unit and may be loaded or otherwise transferred to a primary storage unit in conjunction with processing the respective data 112, executing the respective instructions 114, or both. In some implementations, the memory 110, or a portion thereof, may be removable memory.

The data 112 can include information, such as input audio data, encoded audio data, decoded audio data, or the like. The instructions 114 can include directions, such as code, for performing any method, or any portion or portions thereof, disclosed herein. The instructions 114 can be realized in hardware, software, or any combination thereof. For example, the instructions 114 may be implemented as information stored in the memory 110, such as a computer program, that may be executed by the processor 120 to perform any of the respective methods, algorithms, aspects, or combinations thereof, as described herein.

Although shown as included in the memory 110, in some implementations, the instructions 114, or a portion thereof, may be implemented as a special purpose processor, or circuitry, that can include specialized hardware for carrying out any of the methods, algorithms, aspects, or combinations thereof, as described herein. Portions of the instructions 114 can be distributed across multiple processors on the same machine or different machines or across a network such as a local area network, a wide area network, the Internet, or a combination thereof.

The processor 120 can include any device or system capable of manipulating or processing a digital signal or other electronic information now-existing or hereafter developed, including optical processors, quantum processors, molecular processors, or a combination thereof. For example, the processor 120 can include a special purpose processor, a central processing unit (CPU), a digital signal processor (DSP), a plurality of microprocessors, one or more microprocessor in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors.

The user interface 130 can include any unit capable of interfacing with a user, such as a virtual or physical keypad, a touchpad, a display, a touch display, a speaker, a microphone, a video camera, a sensor, or any combination thereof. For example, the user interface 130 may be an audio-visual display device, and the computing device 100 may present audio, such as decoded audio, using the user interface 130 audio-visual display device, such as in conjunction with displaying video, such as decoded video. Although shown as a single unit, the user interface 130 may include one or more physical units. For example, the user interface 130 may include an audio interface for performing audio communication with a user, and a touch display for performing visual and touch-based communication with the user.

The electronic communication unit 140 can transmit, receive, or transmit and receive signals via a wired or wireless electronic communication medium 180, such as a radio frequency (RF) communication medium, an ultraviolet (UV) communication medium, a visible light communication medium, a fiber optic communication medium, a wireline communication medium, or a combination thereof. For example, as shown, the electronic communication unit 140 is operatively connected to an electronic communication interface 142, such as an antenna, configured to communicate via wireless signals.

Although the electronic communication interface 142 is shown as a wireless antenna in FIG. 1, the electronic communication interface 142 can be a wireless antenna, as shown, a wired communication port, such as an Ethernet port, an infrared port, a serial port, or any other wired or wireless unit capable of interfacing with a wired or wireless electronic communication medium 180. Although FIG. 1 shows a single electronic communication unit 140 and a single electronic communication interface 142, any number of electronic communication units and any number of electronic communication interfaces can be used.

The sensor 150 may include, for example, an audio-sensing device, a visible light-sensing device, a motion sensing device, or a combination thereof. For example, 100the sensor 150 may include a sound-sensing device, such as a microphone, or any other sound-sensing device now existing or hereafter developed that can sense sounds in the proximity of the computing device 100, such as speech or other utterances, made by a user operating the computing device 100. In another example, the sensor 150 may include a camera, or any other image-sensing device now existing or hereafter developed that can sense an image such as the image of a user operating the computing device. Although a single sensor 150 is shown, the computing device 100 may include a number of sensors 150. For example, the computing device 100 may include a first camera oriented with a field of view directed toward a user of the computing device 100 and a second camera oriented with a field of view directed away from the user of the computing device 100.

The power source 160 can be any suitable device for powering the computing device 100. For example, the power source 160 can include a wired external power source interface; one or more dry cell batteries, such as nickel-cadmium (NiCd), nickel-zinc (NiZn), nickel metal hydride (NiMH), lithium-ion (Li-ion); solar cells; fuel cells; or any other device capable of powering the computing device 100. Although a single power source 160 is shown in FIG. 1, the computing device 100 may include multiple power sources 160, such as a battery and a wired external power source interface.

Although shown as separate units, the electronic communication unit 140, the electronic communication interface 142, the user interface 130, the power source 160, or portions thereof, may be configured as a combined unit. For example, the electronic communication unit 140, the electronic communication interface 142, the user interface 130, and the power source 160 may be implemented as a communications port capable of interfacing with an external display device, providing communications, power, or both.

One or more of the memory 110, the processor 120, the user interface 130, the electronic communication unit 140, the sensor 150, or the power source 160, may be operatively coupled via a bus 170. Although a single bus 170 is shown in FIG. 1, a computing device 100 may include multiple buses. For example, the memory 110, the processor 120, the user interface 130, the electronic communication unit 140, the sensor 150, and the bus 170 may receive power from the power source 160 via the bus 170. In another example, the memory 110, the processor 120, the user interface 130, the electronic communication unit 140, the sensor 150, the power source 160, or a combination thereof, may communicate data, such as by sending and receiving electronic signals, via the bus 170.

Although not shown separately in FIG. 1, one or more of the processor 120, the user interface 130, the electronic communication unit 140, the sensor 150, or the power source 160 may include internal memory, such as an internal buffer or register. For example, the processor 120 may include internal memory (not shown) and may read data 112 from the memory 110 into the internal memory (not shown) for processing.

Although shown as separate elements, the memory 110, the processor 120, the user interface 130, the electronic communication unit 140, the sensor 150, the power source 160, and the bus 170, or any combination thereof can be integrated in one or more electronic units, circuits, or chips.

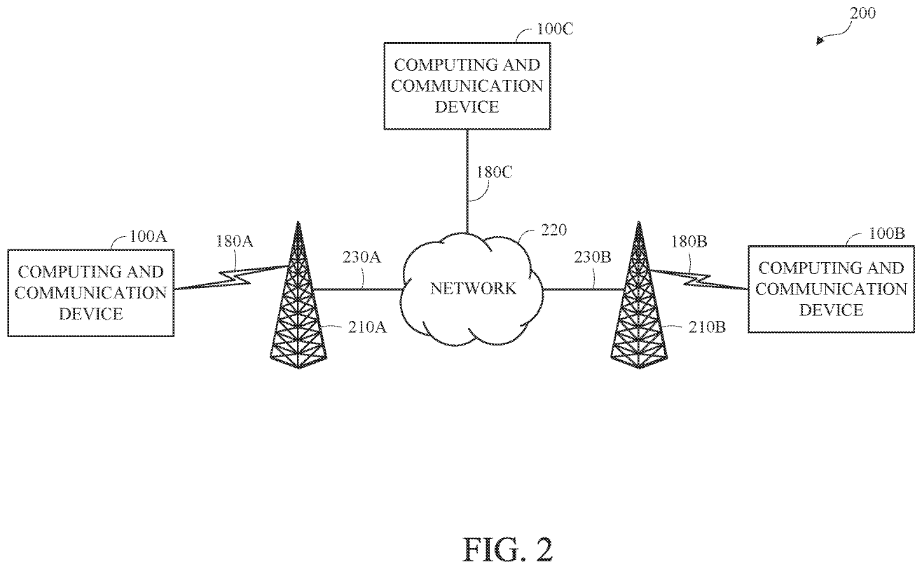

FIG. 2 is a diagram of a computing and communications system 200 in accordance with implementations of this disclosure. The computing and communications system 200 shown includes computing and communication devices 100A, 100B, 100C, access points 210A, 210B, and a network 220. For example, the computing and communication system 200 can be a multiple access system that provides communication, such as voice, audio, data, video, messaging, broadcast, or a combination thereof, to one or more wired or wireless communicating devices, such as the computing and communication devices 100A, 100B, 100C. Although, for simplicity, FIG. 2 shows three computing and communication devices 100A, 100B, 100C, two access points 210A, 210B, and one network 220, any number of computing and communication devices, access points, and networks can be used.

A computing and communication device 100A, 100B, 100C can be, for example, a computing device, such as the computing device 100 shown in FIG. 1. For example, the computing and communication devices 100A, 100B may be user devices, such as a mobile computing device, a laptop, a thin client, or a smartphone, and the computing and communication device 100C may be a server, such as a mainframe or a cluster. Although the computing and communication device 100A and the computing and communication device 100B are described as user devices, and the computing and communication device 100C is described as a server, any computing and communication device may perform some or all of the functions of a server, some or all of the functions of a user device, or some or all of the functions of a server and a user device. For example, the server computing and communication device 100C may receive, encode, process, store, transmit, or a combination thereof audio data and one or both of the computing and communication device 100A and the computing and communication device 100B may receive, decode, process, store, present, or a combination thereof the audio data.

Each computing and communication device 100A, 100B, 100C, which may include a user equipment (UE), a mobile station, a fixed or mobile subscriber unit, a cellular telephone, a personal computer, a tablet computer, a server, consumer electronics, or any similar device, can be configured to perform wired or wireless communication, such as via the network 220. For example, the computing and communication devices 100A, 100B, 100C can be configured to transmit or receive wired or wireless communication signals. Although each computing and communication device 100A, 100B, 100C is shown as a single unit, a computing and communication device can include any number of interconnected elements.

Each access point 210A, 210B can be any type of device configured to communicate with a computing and communication device 100A, 100B, 100C, a network 220, or both via wired or wireless communication links 180A, 180B, 180C. For example, an access point 210A, 210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A, 210B is shown as a single unit, an access point can include any number of interconnected elements.

The network 220 can be any type of network configured to provide services, such as voice, data, applications, voice over internet protocol (VOIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the HyperText Transport Protocol (HTTP), or a combination thereof.

The computing and communication devices 100A, 100B, 100C can communicate with each other via the network 220 using one or more a wired or wireless communication links, or via a combination of wired and wireless communication links. For example, as shown the computing and communication devices 100A, 100B can communicate via wireless communication links 180A, 180B, and computing and communication device 100C can communicate via a wired communication link 180C. Any of the computing and communication devices 100A, 100B, 100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A, 210B can communicate with the network 220 via one or more types of wired or wireless communication links 230A, 230B. Although FIG. 2 shows the computing and communication devices 100A, 100B, 100C in communication via the network 220, the computing and communication devices 100A, 100B, 100C can communicate with each other via any number of communication links, such as a direct wired or wireless communication link.

In some implementations, communications between one or more of the computing and communication device 100A, 100B, 100C may omit communicating via the network 220 and may include transferring data via another medium (not shown), such as a data storage device. For example, the server computing and communication device 100C may store audio data, such as encoded audio data, in a data storage device, such as a portable data storage unit, and one or both of the computing and communication device 100A or the computing and communication device 100B may access, read, or retrieve the stored audio data from the data storage unit, such as by physically disconnecting the data storage device from the server computing and communication device 100C and physically connecting the data storage device to the computing and communication device 100A or the computing and communication device 100B.

Other implementations of the computing and communications system 200 are possible. For example, in an implementation, the network 220 can be an ad-hoc network and can omit one or more of the access points 210A, 210B. The computing and communications system 200 may include devices, units, or elements not shown in FIG. 2. For example, the computing and communications system 200 may include many more communicating devices, networks, and access points.

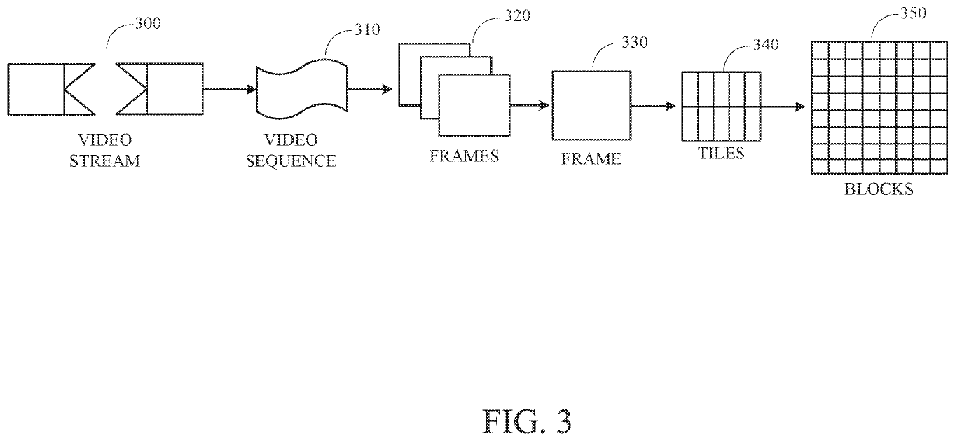

FIG. 3 is a diagram of a video stream 300 for use in encoding and decoding in accordance with implementations of this disclosure. A video stream 300, such as a video stream captured by a video camera or a video stream generated by a computing device, may include a video sequence 310. The video sequence 310 may include a sequence of adjacent frames 320. Although three adjacent frames 320 are shown, the video sequence 310 can include any number of adjacent frames 320.

Each frame 330 from the adjacent frames 320 may represent a single image from the video stream. Although not shown in FIG. 3, a frame 330 may include one or more segments, tiles, or planes, which may be coded, or otherwise processed, independently, such as in parallel. A frame 330 may include one or more tiles 340. Each of the tiles 340 may be a rectangular region of the frame that can be coded independently. Each of the tiles 340 may include respective blocks 350. Although not shown in FIG. 3, a block can include pixels. For example, a block can include a 16×16 group of pixels, an 8×8 group of pixels, an 8×16 group of pixels, or any other group of pixels. Unless otherwise indicated herein, the term ‘block’ can include a superblock, a macroblock, a segment, a slice, or any other portion of a frame. A frame, a block, a pixel, or a combination thereof can include display information, such as luminance information, chrominance information, or any other information that can be used to store, modify, communicate, or display the video stream or a portion thereof.

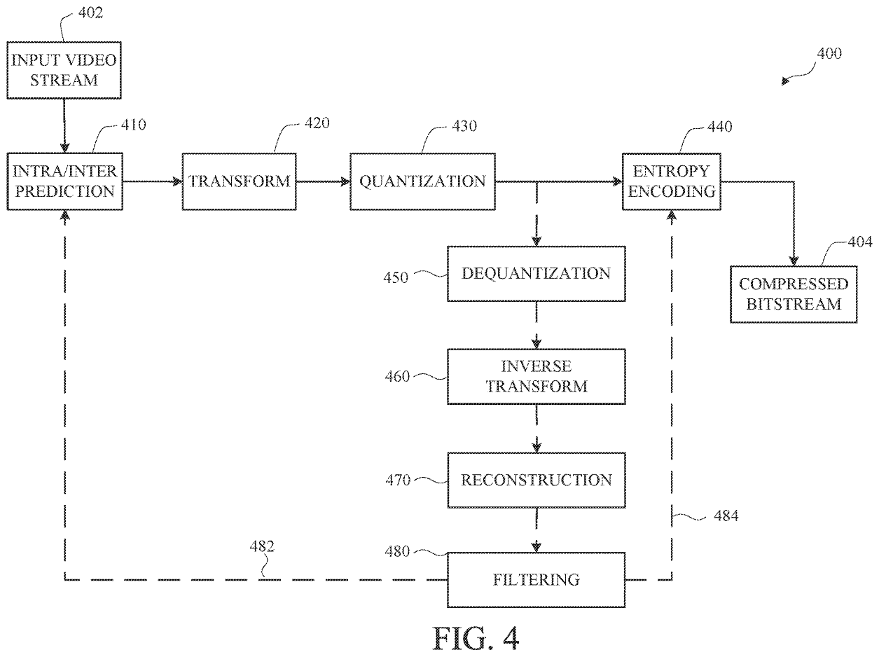

FIG. 4 is a block diagram of an encoder 400 in accordance with implementations of this disclosure. Encoder 400 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to encode video data as described herein. The encoder 400 can be implemented as specialized hardware included, for example, in computing device 100.

The encoder 400 can encode an input video stream 402, such as the video stream 300 shown in FIG. 3, to generate an encoded (compressed) bitstream 404. In some implementations, the encoder 400 may include a forward path for generating the compressed bitstream 404. The forward path may include an intra/inter prediction unit 410, a transform unit 420, a quantization unit 430, an entropy encoding unit 440, or any combination thereof. In some implementations, the encoder 400 may include a reconstruction path (indicated by the broken connection lines) to reconstruct a frame for encoding of further blocks. The reconstruction path may include a dequantization unit 450, an inverse transform unit 460, a reconstruction unit 470, a filtering unit 480, or any combination thereof. Other structural variations of the encoder 400 can be used to encode the video stream 402.

For encoding the video stream 402, each frame within the video stream 402 can be processed in units of blocks. Thus, a current block may be identified from the blocks in a frame, and the current block may be encoded.

At the intra/inter prediction unit 410, the current block can be encoded using either intra-frame prediction, which may be within a single frame, or inter-frame prediction, which may be from frame to frame. Intra-prediction may include generating a prediction block from samples in the current frame that have been previously encoded and reconstructed. Inter-prediction may include generating a prediction block from samples in one or more previously constructed reference frames. Generating a prediction block for a current block in a current frame may include performing motion estimation to generate a motion vector indicating an appropriate reference portion of the reference frame.

The intra/inter prediction unit 410 may subtract the prediction block from the current block (raw block) to produce a residual block. The transform unit 420 may perform a block-based transform, which may include transforming the residual block into transform coefficients in, for example, the frequency domain. Examples of block-based transforms include the Karhunen-Loève Transform (KLT), the Discrete Cosine Transform (DCT), the Singular Value Decomposition Transform (SVD), and the Asymmetric Discrete Sine Transform (ADST). In an example, the DCT may include transforming a block into the frequency domain. The DCT may include using transform coefficient values based on spatial frequency, with the lowest frequency (i.e. DC) coefficient at the top-left of the matrix and the highest frequency coefficient at the bottom-right of the matrix.

The quantization unit 430 may convert the transform coefficients into discrete quantum values, which may be referred to as quantized transform coefficients or quantization levels. The quantized transform coefficients can be entropy encoded by the entropy encoding unit 440 to produce entropy-encoded coefficients. Entropy encoding can include using a probability distribution metric. The entropy-encoded coefficients and information used to decode the block, which may include the type of prediction used, motion vectors, and quantizer values, can be output to the compressed bitstream 404. The compressed bitstream 404 can be formatted using various techniques, such as run-length encoding (RLE) and zero-run coding.

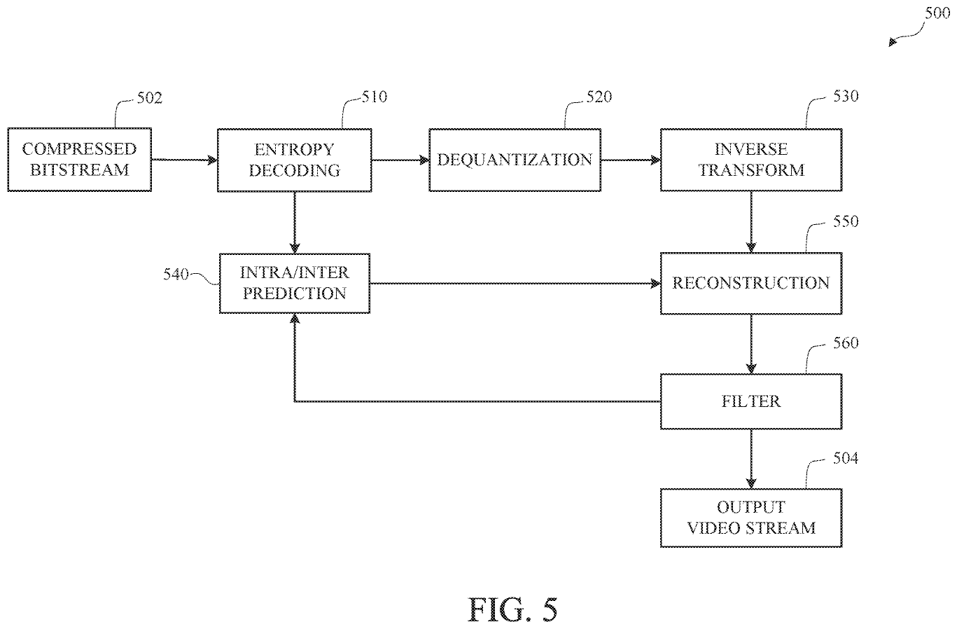

The reconstruction path can be used to maintain reference frame synchronization between the encoder 400 and a corresponding decoder, such as the decoder 500 shown in FIG. 5. The reconstruction path may be similar to the decoding process discussed below and may include decoding the encoded frame, or a portion thereof, which may include decoding an encoded block, which may include dequantizing the quantized transform coefficients at the dequantization unit 450 and inverse transforming the dequantized transform coefficients at the inverse transform unit 460 to produce a derivative residual block. The reconstruction unit 470 may add the prediction block generated by the intra/inter prediction unit 410 to the derivative residual block to create a decoded block. The filtering unit 480 can be applied to the decoded block to generate a reconstructed block, which may reduce distortion, such as blocking artifacts. Although one filtering unit 480 is shown in FIG. 4, filtering the decoded block may include loop filtering, deblocking filtering, or other types of filtering or combinations of types of filtering. The reconstructed block may be stored or otherwise made accessible as a reconstructed block, which may be a portion of a reference frame, for encoding another portion of the current frame, another frame, or both, as indicated by the broken line at 482. Coding information, such as deblocking threshold index values, for the frame may be encoded, included in the compressed bitstream 404, or both, as indicated by the broken line at 484.

Other variations of the encoder 400 can be used to encode the compressed bitstream 404. For example, a non-transform-based encoder 400 can quantize the residual block directly without the transform unit 420. In some implementations, the quantization unit 430 and the dequantization unit 450 may be combined into a single unit.

FIG. 5 is a block diagram of a decoder 500 in accordance with implementations of this disclosure. The decoder 500 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to decode video data as described herein. The decoder 500 can be implemented as specialized hardware included, for example, in computing device 100.

The decoder 500 may receive a compressed bitstream 502, such as the compressed bitstream 404 shown in FIG. 4, and may decode the compressed bitstream 502 to generate an output video stream 504. The decoder 500 may include an entropy decoding unit 510, a dequantization unit 520, an inverse transform unit 530, an intra/inter prediction unit 540, a reconstruction unit 550, a filtering unit 560, or any combination thereof. Other structural variations of the decoder 500 can be used to decode the compressed bitstream 502.

The entropy decoding unit 510 may decode data elements within the compressed bitstream 502 using, for example, Context Adaptive Binary Arithmetic Decoding, to produce a set of quantized transform coefficients. The dequantization unit 520 can dequantize the quantized transform coefficients, and the inverse transform unit 530 can inverse transform the dequantized transform coefficients to produce a derivative residual block, which may correspond to the derivative residual block generated by the inverse transform unit 460 shown in FIG. 4. Using header information decoded from the compressed bitstream 502, the intra/inter prediction unit 540 may generate a prediction block corresponding to the prediction block created in the encoder 400. At the reconstruction unit 550, the prediction block can be added to the derivative residual block to create a decoded block. The filtering unit 560 can be applied to the decoded block to reduce artifacts, such as blocking artifacts, which may include loop filtering, deblocking filtering, or other types of filtering or combinations of types of filtering, and which may include generating a reconstructed block, which may be output as the output video stream 504.

Other variations of the decoder 500 can be used to decode the compressed bitstream 502. For example, the decoder 500 can produce the output video stream 504 without a deblocking filtering unit.

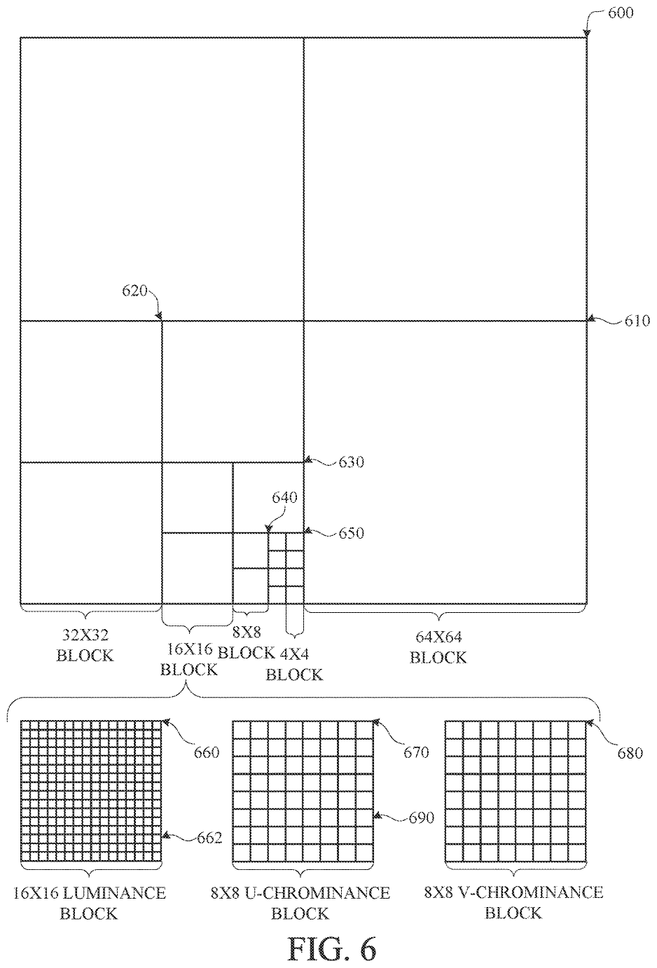

FIG. 6 is a block diagram of a representation of a portion 600 of a frame, such as the frame 330 shown in FIG. 3. FIG. 6 is used to describe using recursive partitioning to code a sequence of blocks.

As shown, the portion 600 of the frame includes four 64×64 blocks 610, in two rows and two columns in a matrix or Cartesian plane. In some implementations, a 64×64 block may be a maximum coding unit, N=64. Each 64×64 block may include four 32×32 blocks 620. Each 32×32 block may include four 16×16 blocks 630. Each 16×16 block may include four 8×8 blocks 640. Each 8×8 block 640 may include four 4×4 blocks 650. Each 4×4 block 650 may include 16 pixels, which may be represented in four rows and four columns in each respective block in the Cartesian plane or matrix. The pixels may include information representing an image captured in the frame, such as luminance information, color information, and location information. In some implementations, a block, such as a 16×16 pixel block as shown, may include a luminance block 660, which may include luminance pixels 662; and two chrominance blocks 670, 680, such as a U or Cb chrominance block 670, and a V or Cr chrominance block 680. The chrominance blocks 670, 680 may include chrominance pixels 690. For example, the luminance block 660 may include 16×16 luminance pixels 662 and each chrominance block 670, 680 may include 8×8 chrominance pixels 690 as shown. Although one arrangement of blocks is shown, any arrangement may be used.

In some implementations, video coding may include ordered block-level coding. Ordered block-level coding may include coding blocks of a frame in an order, such as raster-scan order, wherein blocks may be identified and processed starting with a block in the upper left corner of the frame, or portion of the frame, and proceeding along rows from left to right and from the top row to the bottom row, identifying each block in turn for processing. For example, the 64×64 block in the top row and left column of a frame may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block may include using quad-tree coding, which may include coding smaller block units within a block in raster-scan order. For example, the 64×64 block shown in the bottom left corner of the portion of the frame shown in FIG. 6, may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8×8 blocks may be omitted for a 16×16 block, and the 16×16 block may be coded using quad-tree coding wherein the top left 4×4 block may be coded, then the other 4×4 blocks in the 16×16 block may be coded in raster-scan order.

In some implementations, video coding may include compressing the information included in an original, or input, frame by, for example, omitting some of the information in the original frame from a corresponding encoded frame. For example, coding may include reducing spectral redundancy, reducing spatial redundancy, reducing temporal redundancy, or a combination thereof.

In some implementations, reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of a frame and using a relatively small amount of information to represent each corresponding chrominance component for the portion of the frame. For example, a portion of a frame may be represented by a high-resolution luminance component, which may include a 16×16 block of pixels, and by two lower resolution chrominance components, each of which represents the portion of the frame as an 8×8 block of pixels. A pixel may indicate a value, for example, a value in the range from 0 to 255, and may be stored or transmitted using, for example, eight bits. Although this disclosure is described in reference to the YUV color model, any color model may be used.

In some implementations, reducing spatial redundancy may include transforming a block into the frequency domain using, for example, a discrete cosine transform (DCT). For example, a unit of an encoder, such as the transform unit 420 shown in FIG. 4, may perform a DCT using transform coefficient values based on spatial frequency.

In some implementations, reducing temporal redundancy may include using similarities between frames to encode a frame using a relatively small amount of data based on one or more reference frames, which may be previously encoded, decoded, and reconstructed frames of the video stream. For example, a block or pixel of a current frame may be similar to a spatially corresponding block or pixel of a reference frame. In some implementations, a block or pixel of a current frame may be similar to block or pixel of a reference frame at a different spatial location and reducing temporal redundancy may include generating motion information indicating the spatial difference, or translation, between the location of the block or pixel in the current frame and corresponding location of the block or pixel in the reference frame.

In some implementations, reducing temporal redundancy may include identifying a portion of a reference frame that corresponds to a current block or pixel of a current frame. For example, a reference frame, or a portion of a reference frame, which may be stored in memory, may be searched to identify a portion for generating a prediction to use for encoding a current block or pixel of the current frame with maximal efficiency. For example, the search may identify a portion of the reference frame for which the difference in pixel values between the current block and a prediction block generated based on the portion of the reference frame is minimized and may be referred to as motion searching. In some implementations, the portion of the reference frame searched may be limited. For example, the portion of the reference frame searched, which may be referred to as the search area, may include a limited number of rows of the reference frame. In an example, identifying the portion of the reference frame for generating a prediction may include calculating a cost function, such as a sum of absolute differences (SAD), between the pixels of portions of the search area and the pixels of the current block.

In some implementations, the spatial difference between the location of the portion of the reference frame for generating a prediction in the reference frame and the current block in the current frame may be represented as a motion vector. The difference in pixel values between the prediction block and the current block may be referred to as differential data, residual data, a prediction error, or as a residual block. In some implementations, generating motion vectors may be referred to as motion estimation, and a pixel of a current block may be indicated based on location using Cartesian coordinates as f_{x,y}. Similarly, a pixel of the search area of the reference frame may be indicated based on location using Cartesian coordinates as r_{x,y}. A motion vector (MV) for the current block may be determined based on, for example, a SAD between the pixels of the current frame and the corresponding pixels of the reference frame.

Although described herein with reference to matrix or Cartesian representation of a frame for clarity, a frame may be stored, transmitted, processed, or any combination thereof, in any data structure such that pixel values may be efficiently represented for a frame or image. For example, a frame may be stored, transmitted, processed, or any combination thereof, in a two-dimensional data structure such as a matrix as shown, or in a one-dimensional data structure, such as a vector array. In an implementation, a representation of the frame, such as a two-dimensional representation as shown, may correspond to a physical location in a rendering of the frame as an image. For example, a location in the top left corner of a block in the top left corner of the frame may correspond with a physical location in the top left corner of a rendering of the frame as an image.

In some implementations, block-based coding efficiency may be improved by partitioning input blocks into one or more prediction partitions, which may be rectangular, including square, partitions for prediction coding. In some implementations, video coding using prediction partitioning may include selecting a prediction partitioning scheme from among multiple candidate prediction partitioning schemes. For example, in some implementations, candidate prediction partitioning schemes for a 64×64 coding unit may include rectangular size prediction partitions ranging in sizes from 4×4 to 64×64, such as 4×4, 4×8, 8×4, 8×8, 8×16, 16×8, 16×16, 16×32, 32×16, 32×32, 32×64, 64×32, or 64×64. In some implementations, video coding using prediction partitioning may include a full prediction partition search, which may include selecting a prediction partitioning scheme by encoding the coding unit using each available candidate prediction partitioning scheme and selecting the best scheme, such as the scheme that produces the least rate-distortion error.

In some implementations, encoding a video frame may include identifying a prediction partitioning scheme for encoding a current block, such as block 610. In some implementations, identifying a prediction partitioning scheme may include determining whether to encode the block as a single prediction partition of maximum coding unit size, which may be 64×64 as shown, or to partition the block into multiple prediction partitions, which may correspond with the sub-blocks, such as the 32×32 blocks 620 the 16×16 blocks 630, or the 8×8 blocks 640, as shown, and may include determining whether to partition into one or more smaller prediction partitions. For example, a 64×64 block may be partitioned into four 32×32 prediction partitions. Three of the four 32×32 prediction partitions may be encoded as 32×32 prediction partitions and the fourth 32×32 prediction partition may be further partitioned into four 16×16 prediction partitions. Three of the four 16×16 prediction partitions may be encoded as 16×16 prediction partitions and the fourth 16×16 prediction partition may be further partitioned into four 8×8 prediction partitions, each of which may be encoded as an 8×8 prediction partition. In some implementations, identifying the prediction partitioning scheme may include using a prediction partitioning decision tree.

In some implementations, video coding for a current block may include identifying an optimal prediction coding mode from multiple candidate prediction coding modes, which may provide flexibility in handling video signals with various statistical properties and may improve the compression efficiency. For example, a video coder may evaluate each candidate prediction coding mode to identify the optimal prediction coding mode, which may be, for example, the prediction coding mode that minimizes an error metric, such as a rate-distortion cost, for the current block. In some implementations, the complexity of searching the candidate prediction coding modes may be reduced by limiting the set of available candidate prediction coding modes based on similarities between the current block and a corresponding prediction block. In some implementations, the complexity of searching each candidate prediction coding mode may be reduced by performing a directed refinement mode search. For example, metrics may be generated for a limited set of candidate block sizes, such as 16×16, 8×8, and 4×4, the error metric associated with each block size may be in descending order, and additional candidate block sizes, such as 4×8 and 8×4 block sizes, may be evaluated.

In some implementations, block-based coding efficiency may be improved by partitioning a current residual block into one or more transform partitions, which may be rectangular, including square, partitions for transform coding. In some implementations, video coding using transform partitioning may include selecting a uniform transform partitioning scheme. For example, a current residual block, such as block 610, may be a 64×64 block and may be transformed without partitioning using a 64×64 transform.

Although not expressly shown in FIG. 6, a residual block may be transform partitioned using a uniform transform partitioning scheme. For example, a 64×64 residual block may be transform partitioned using a uniform transform partitioning scheme including four 32×32 transform blocks, using a uniform transform partitioning scheme including sixteen 16×16 transform blocks, using a uniform transform partitioning scheme including sixty-four 8×8 transform blocks, or using a uniform transform partitioning scheme including two hundred fifty-six 4×4 transform blocks.

In some implementations, video coding using transform partitioning may include identifying multiple transform block sizes for a residual block using multiform transform partition coding. In some implementations, multiform transform partition coding may include recursively determining whether to transform a current block using a current block size transform or by partitioning the current block and multiform transform partition coding each partition. For example, the bottom left block 610 shown in FIG. 6 may be a 64×64 residual block, and multiform transform partition coding may include determining whether to code the current 64×64 residual block using a 64×64 transform or to code the 64×64 residual block by partitioning the 64×64 residual block into partitions, such as four 32×32 blocks 620, and multiform transform partition coding each partition. In some implementations, determining whether to transform partition the current block may be based on comparing a cost for encoding the current block using a current block size transform to a sum of costs for encoding each partition using partition size transforms.

As initially described, and although not shown in FIG. 6, a block may be partitioned using a binary split. For example, the bottom-right of the portion 600 may be subject to a binary horizontal split such that two 32×64 blocks (one on top of the other) are formed or may be subject to a binary vertical split such that two 64×32 blocks (one on top of the other) are formed. This binary split type may be used as a partition choice in the description above. along with the two-way quad split. Stated more generally, if a block comprises a 2N×2N block, the partition choices for the recursive partitioning may be no partition (e.g., 2N×2N), a quad type partition N×N, a horizontal type partition N×2N, or a vertical type partition 2N×N. A ternary type partition that results in three blocks, namely 2N×N/2, 2N×N, and 2N×N/2 arranged vertically in sequence or N/2×2N, N×2N, and N/2×N arranged horizontally in sequence, is also possible. This partition type, while adding some flexibility to the partitioning, can cause a level of tree-entanglement with binary horizontal and vertical splits that can potentially result in efficiency loss.

The multi-tree recursive partitioning schemes herein can partition blocks with dimensions defined by powers of two and blocks with other dimensions using a set of categories based on block sizes. Each category of the set of categories may be identified by unique, unordered pairs of multipliers for power-of-two values for possible/available widths and heights of blocks of image data. Each category has a fixed set of partitions (e.g., binary, ternary, quad, etc., partitions). During coding (i.e., encoding or decoding), the partitioning of a block is determined by using the dimensions of the block to determine its category and selecting the split-type from the available split-types within the category that corresponds to the dimensions. Note that the size of a block and its (pixel) dimensions may be referred to interchangeably herein.

Next described is the framework for a determination of a set of categories for a multi-tree recursive partitioning scheme according to the teachings herein.

Each category may be determined by the width and height of blocks. Consider a block of size p*2^{m}×q*2ⁿ (in conventional width x height order), where p and q are each an odd number. Further, m and n are each a positive integer, where m and n may be different values or may be the same value. The category of a block is determined by the unordered pair (p,q). Unordered means that a block of p*2^{m}×q*2ⁿ is in the same category as a 90-degree rotated block of size q*2ⁿ×p*2^{m}.

The unordered pair (p,q)=(1,1) corresponds to the case where a size of the block is a power of 2 in both dimensions—also referred to herein as a power-of-two block. Other unordered pairs may comprise (1,3), (3,3), (1,5), (5,5), etc. As an example, where n=m=2, corresponding block sizes are 2×6 and 6×2, 6×6, 2×10 and 10×2, and 10×10, etc.

A multi-tree partitioning scheme of the multi-tree recursive partitioning schemes according to the teachings herein assumes there are C categories in the set of categories, where each category is defined by a unique, unordered pair (p, q). A block of each category is associated with a distinct set of block split-type options such that each resultant sub-partition in each available block split-type option also belongs to the available set of C categories. In other words, no sub-partition of a block within a category of the set produces a block size that is different from a category already defined within the set. Each sub-partition (sub-block) can then be further recursively split into one of (e.g., several) options available based on the category of the sub-partition. This continues until a block cannot be further split because of a minimum block size restriction and/or because a no-split signal is signaled for the block.

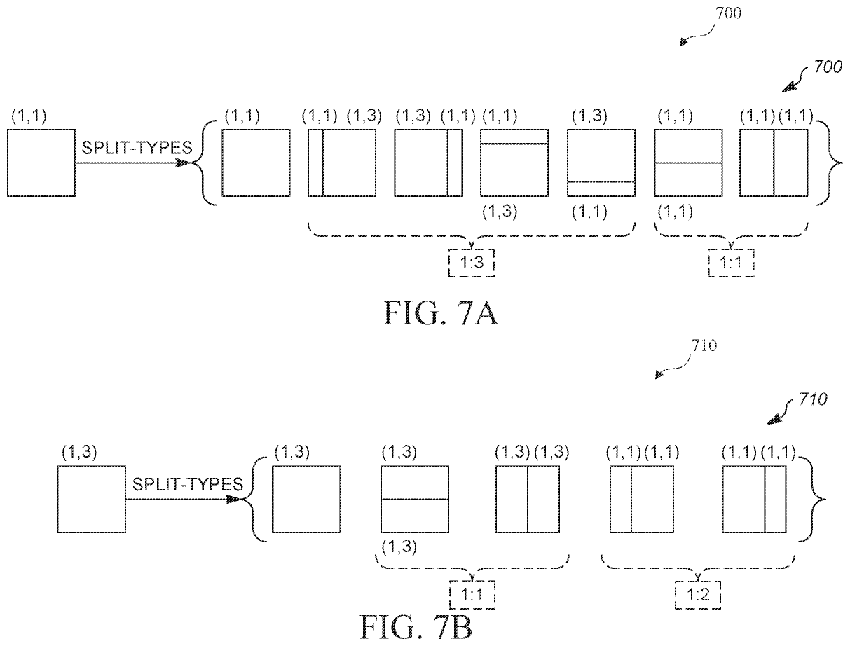

Examples of sets of categories that form a multi-tree recursive partitioning scheme according to the teachings herein may be seen with reference to examples of such sets of categories shown respectively in FIGS. 7A and 7B, 8A to 8C, 9A and 9B, and 10A to 10C.

These are by example only, and other multi-tree recursive partitioning schemes are possible given the principles described herein. In each of these figures, the labels grouping partitions (1:3, 1:2, etc.) indicate how to split the pixels of the block to form the sub-blocks, and the labels for each sub-block indicate the unordered pair corresponding to the block size.

FIGS. 7A and 7B are diagrams of a multi-tree partitioning scheme using two categories in accordance with this disclosure. The first tree or category 700 of the set of categories of the partitioning scheme comprises split-types for a block with dimensions defined by an unordered pair (1,1), and the second tree category 710 of the set comprises split-types for a block with dimensions defined by an unordered pair (1,3). Recall that (1,1) denotes a block that is power-of-two in both dimensions, and (1,3) denotes a block that is power-of-two in one dimension and 3 times a power of 2 in the other dimension. Only binary splits are used in each category. Each sub-partition can be recursively split using the trees until a minimum block-size constraint is reached. For example, a split-type for a block that results in a sub-block having horizontal or vertical dimension of less than 4 pixels may not be used in the recursive partitioning.

Referring first to FIG. 7A, the split-types for the first category 700 include, from left to right, a no split-type, four uneven unidirectional binary split-types labeled 1:3, in particular two uneven vertical binary split-types and two uneven horizontal binary split-types, and two even binary split-types labeled 1:1. A no split-type means that the current block is not (further) partitioned. The uneven unidirectional binary split-types use a vertical or horizontal partition only where the first ¼ of the N pixels along the first axis are assigned to a first partition (or first sub-block), and the next ¾ of the N pixels along first axis are assigned to a second partition (or second sub-block). The pixel dimension along the second axis orthogonal to the first axis for each sub-block is the original dimension of the block (1,1). Examples using a 64×64 (26×26) block for the block (N, N) to be partitioned in FIG. 7A follow. The sub-blocks of the first uneven vertical binary split-type would have the dimensions 16×64 pixels and 48×64 pixels. That is, the dimensions would be ¼*2⁶×2⁶ (1*2⁴×1*2⁶) and ¾*2⁶×2⁶ (3*2⁴×1*2⁶), respectively. The sub-blocks of the second uneven vertical binary split-type would be similarly determined and have the dimensions 48×64 pixels (3*2⁴×1*2⁶) and 16×64 (1*2⁴×1*2⁶) pixels. Similarly, the sub-blocks of the first uneven horizontal binary split-type would have the dimensions 64×16 pixels (1*2⁶×1*2⁴) and 64×48 pixels (1*2⁶×3*2⁴). The sub-blocks of the second uneven binary split-type would have the dimensions 64×48 pixels (1*2⁶×3*2⁴) and 64×16 pixels (1*2⁶×1*2⁴).

The two even binary split-types shown in FIG. 7A correspond to respectively to the horizontal binary split-type and the vertical binary split-type described above where the first ½ of the N pixels along the first axis are assigned to a first partition (or first sub-block), and the second ½ of the N pixels along first axis are assigned to a second partition (or second sub-block). The pixel dimension along the second axis orthogonal to the first axis for each sub-block is the original dimension of the block along the second axis.

Referring next to FIG. 7B, the split-types for the second category 710 include, from left to right, a no split-type, two even binary split-types labeled 1:1, and two uneven unidirectional binary split-types labeled 1:2, in particular two uneven vertical binary split-types. A no split-type means that the current block (N, M) is not (further) partitioned. The two even binary split-types shown in FIG. 7A correspond to respectively to the (even) horizontal binary split-type and the (even) vertical binary split-type described above where the first ½ of the N pixels along the first axis are assigned to a first partition (or first sub-block), and the second ½ of the N pixels along first axis are assigned to a second partition (or second sub-block). The pixel dimension along the second axis orthogonal to the first axis for each sub-block is the original dimension of the block (1,3).

The uneven unidirectional binary split-types use a vertical partition only. In the first uneven vertical binary split-type, the first ⅓ of the N pixels along the horizontal axis are assigned to a first partition (or first sub-block), and the final ⅔ of the N pixels along horizontal axis are assigned to a second partition (or second sub-block). The pixel dimension along the vertical axis orthogonal to the horizontal axis for each sub-block is the original dimension of the block along the vertical axis. In the second uneven vertical binary split-type, the first ⅔ of the N pixels along the horizontal axis are assigned to a first partition (or first sub-block), and the final ⅓ of the N pixels along horizontal axis are assigned to a second partition (or second sub-block). The pixel dimension along the vertical axis orthogonal to the horizontal axis for each sub-block is the original dimension of the block along the vertical axis. Examples using a 48×64 (3*2⁴×1*2⁶) block for the block (N, M) to be partitioned in FIG. 7B follow. Note that this block belongs to the category of the unordered pair (1,3) and results from partitioning of a block that belongs to the category of the unordered pair (1,1) in FIG. 7A.

The sub-blocks of the horizontal binary split-type would have the dimensions 48×32 (48×½*64). That is, the dimensions would be 3*2⁴×½*1*2⁶ (3*2⁴×1*2⁵). The sub-blocks of the vertical binary split-type would be 24×64 according to ½*3*2⁴×1*2⁶ (3*2³×1*2⁶). The first uneven vertical binary split-type would have the dimensions 16×64 pixels and 32×64 pixels. That is, the dimensions would be ⅓*3*2⁴×1*2⁶ (1*2⁴×1*2⁶) and ⅔*3*2⁴×1*2⁶ (1*2⁵×1*2⁶), respectively. The sub-blocks of the second uneven vertical binary split-type would be similarly determined and have the dimensions 32×64 pixels (1*2⁵×1*2⁶) and 16×64 pixels (1*2⁴×1*2⁶).

As can be seen from the above, the multi-tree partitioning scheme comprising the first category 700 of FIG. 7A and the second category of FIG. 7B satisfies the conditions outlined above. Namely, the partition of every block that belongs to the category of the unordered pair (1,1) results in sub-block(s) that to belong to the category of the unordered pair (1,1) or the category of the unordered pair (1,3), and the partition of every block that belongs to the category of the unordered pair (1,3) results in sub-block(s) that to belong to the category of the unordered pair (1,1) or the category of the unordered pair (1,3).

Note that many variations of the above multi-tree partitioning scheme are possible. For instance, in one embodiment for the split-types of the category 710, the no-split option can be skipped. In another embodiment, the 1:1 split-types for the category 710 can be skipped. In yet another embodiment, only one of the 1:2 split-types for the category 710 can be kept based on the parent's split-type. These options eliminate redundancy in multiple ways to achieve the same partition.

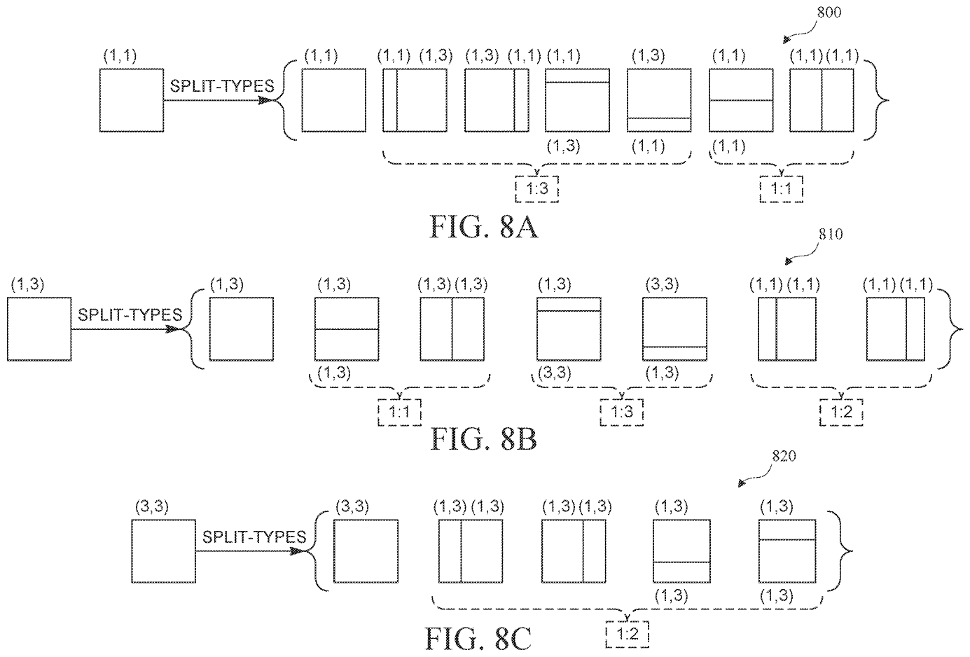

FIGS. 8A, 8B, and 8C are diagrams of a multi-tree partitioning scheme using three categories in accordance with this disclosure. The first tree or category 800 of the set of categories of the partitioning scheme comprises split-types for a block with dimensions defined by an unordered pair (1,1), the second tree or category 810 of the set comprises split-types for a block with dimensions defined by an unordered pair (1,3), and the third tree or category 820 of the set comprises split-types for a block with dimensions defined by an unordered pair (3,3). Recall that (1,1) denotes a block that is power-of-two in both dimensions, and (1,3) denotes a block that is power-of-two in one dimension and 3 times a power of 2 in the other dimension, and (3,3) denotes a block that is 3 times a power-of-two in both dimensions. Only binary splits are used in each category. Each sub-partition can be recursively split using the trees until a minimum block-size constraint is reached. For example, a split-type for a block that results in a sub-block having horizontal or vertical dimension of less than 4 pixels may not be used in the recursive partitioning.

Referring first to FIG. 8A, the split-types for the first category 800 are the same as those of the split-types for the first category 700. Referring next to FIG. 8B, the split-types for the second category 810 include, from left to right, a no split-type, two even binary split-types labeled 1:1, two uneven horizontal binary split-types labeled 1:3, and two uneven vertical binary split-types labeled 1:2. Finally, the split-types for the third category 820 shown in FIG. 8C include, from left to right, a no split-type and four uneven unidirectional binary split-types labeled 1:2, in particular two uneven horizontal binary split-types labeled 1:3, and two uneven vertical binary split-types labeled 1:2.

As can be seen FIGS. 8A to 8C, the multi-tree partitioning scheme comprising the first category 800 of FIG. 8A, the second category 810 of FIG. 8B, and the third category 820 of FIG. 8C satisfies the conditions outlined above. Namely, the partition of every block that belongs to the category of the unordered pair (1,1), the unordered pair (1,3), or the ordered pair (3,3) results in sub-blocks that are limited to the same categories. For example, the partition of every block that belongs to the category of the unordered pair (1,1) result in sub-block(s) that belong to the category of the unordered pair (1,1) or the unordered pair (1,3), the partition of every block that belongs to the category of the unordered pair (1,3) results in sub-block(s) that belong to the category of the unordered pair (1,1), the category of the unordered pair (1,3), or the category of the unordered pair (3,3), and the partition of every block that belongs to the category of the unordered pair (3,3) results in sub-block(s) that belong to the category of the unordered pair (1,3) or the category of the unordered pair (3,3).

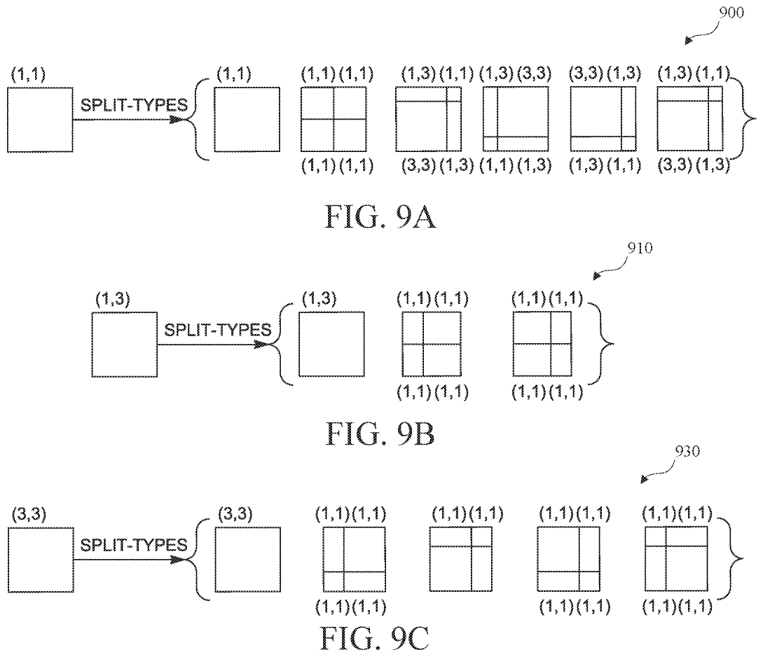

FIGS. 9A, 9B, and 9C are diagrams of another multi-tree partitioning scheme using three categories in accordance with this disclosure. The first tree or category 900 of the set of categories of the partitioning scheme comprises split-types for a block with dimensions defined by an unordered pair (1,1), the second tree or category 910 of the set comprises split-types for a block with dimensions defined by an unordered pair (1,3), and the third tree or category 930 of the set comprises split-types for a block with dimensions defined by an unordered pair (3,3). Recall that (1,1) denotes a block that is power-of-two in both dimensions, and (1,3) denotes a block that is power-of-two in one dimension and 3 times a power of 2 in the other dimension, and (3,3) denotes a block that is 3 times a power-of-two in both dimensions. In contrast to FIGS. 8A to 8C, only quad splits are used in each category. Each sub-partition can be recursively split using the trees until a minimum block-size constraint is reached. For example, a split-type for a block that results in a sub-block having horizontal or vertical dimension of less than 4 pixels may not be used in the recursive partitioning.

Referring first to FIG. 9A, the split-types for the first category 900 include from left to right, a no split-type, an even quad split-type, and four uneven quad split-types. Referring next to FIG. 9B, the split-types for the second category 910 include, from left to right, a no split-type and two uneven quad split-types. Finally, the split-types for the third category 930 shown in FIG. 9C include, from left to right, a no split-type and four uneven quad split-types labeled 1:2.

As can be seen FIGS. 9A to 9C, the multi-tree partitioning scheme comprising the first category 900 of FIG. 9A, the second category 910 of FIG. 9B, and the third category 930 of FIG. 9C satisfies the conditions outlined above. Namely, the partition of every block that belongs to one of the categories 900, 910, 930 of the multi-tree partitioning scheme results in sub-block(s) that each belong to one of the same categories 900, 910, 930.

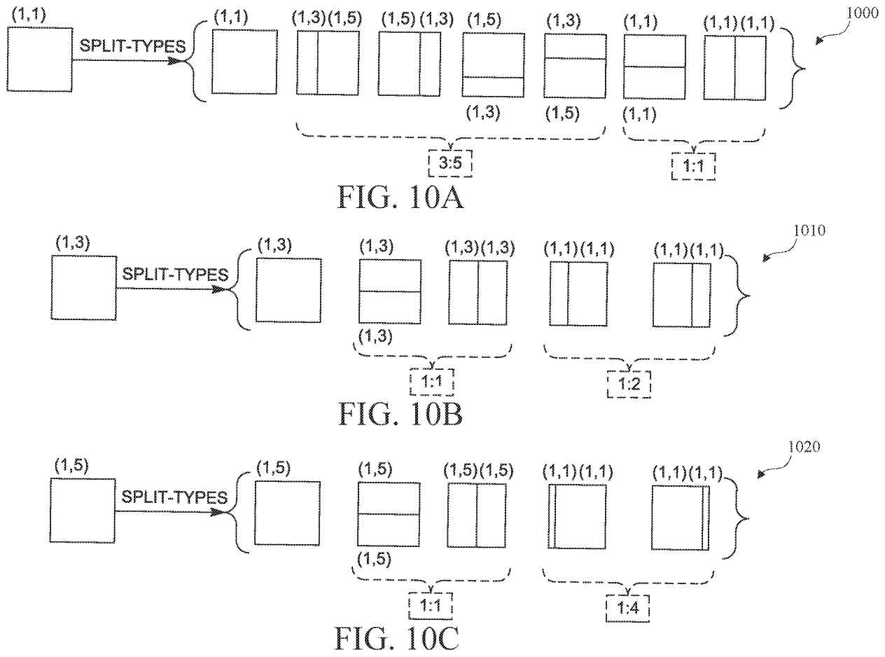

FIGS. 10A, 10B, and 10C are diagrams of yet another multi-tree partitioning scheme using three categories in accordance with this disclosure. The first tree or category 1000 of the set of categories of the partitioning scheme comprises split-types for a block with dimensions defined by an unordered pair (1,1), the second tree or category 1010 of the set comprises split-types for a block with dimensions defined by an unordered pair (1,3), and the third tree or category 1020 of the set comprises split-types for a block with dimensions defined by an unordered pair (1,5). Recall that (1,1) denotes a block that is power-of-two in both dimensions, (1,3) denotes a block that is power-of-two in one dimension and 3 times a power of 2 in the other dimension, and (1,5) denotes a block that is power-of-two in one dimension and 5 times a power of 2 in the other dimension.

Like FIGS. 8A to 8C, only binary splits are used in each category of this multi-partitioning scheme. However, the inclusion of a category directed to the unordered pair (1,5) allows this partitioning scheme a ⅜, ⅝ split of a block belonging to the unordered pair (1,1) to produce sub-blocks belonging to the unordered pair (1,3) and the unordered pair (1,5). Each sub-partition can be recursively split using the trees until a minimum block-size constraint is reached. For example, a split-type for a block that results in a sub-block having horizontal or vertical dimension of less than 4 pixels may not be used in the recursive partitioning.

Referring first to FIG. 10A, the split-types for the first category 1000 include from left to right, a no split-type, four uneven unidirectional binary split-types labeled 3:5, in particular two uneven vertical binary split-types and two uneven horizontal binary split-types, and two even binary split-types labeled 1:1. Referring next to FIG. 10B, the split-types for the second category 1010 include, from left to right, a no split-type, two even binary split-types labeled 1:1, and two uneven vertical binary split-types labeled 1:2. Finally, the split-types for the third category 1020 shown in FIG. 10C include, from left to right, a no split-type, two even binary split-types labeled 1:1, and two uneven vertical binary split-types labeled 1:4.

As can be seen FIGS. 10A to 10C, the multi-tree partitioning scheme comprising the first category 1000 of FIG. 10A, the second category 1010 of FIG. 10B, and the third category 1020 of FIG. 10C satisfies the conditions outlined above. Namely, the partition of every block that belongs to one of the categories 1000, 1010, 1020 of the multi-tree partitioning scheme results in sub-block(s) that each belong to one of the same categories 1000, 1010, 1020.

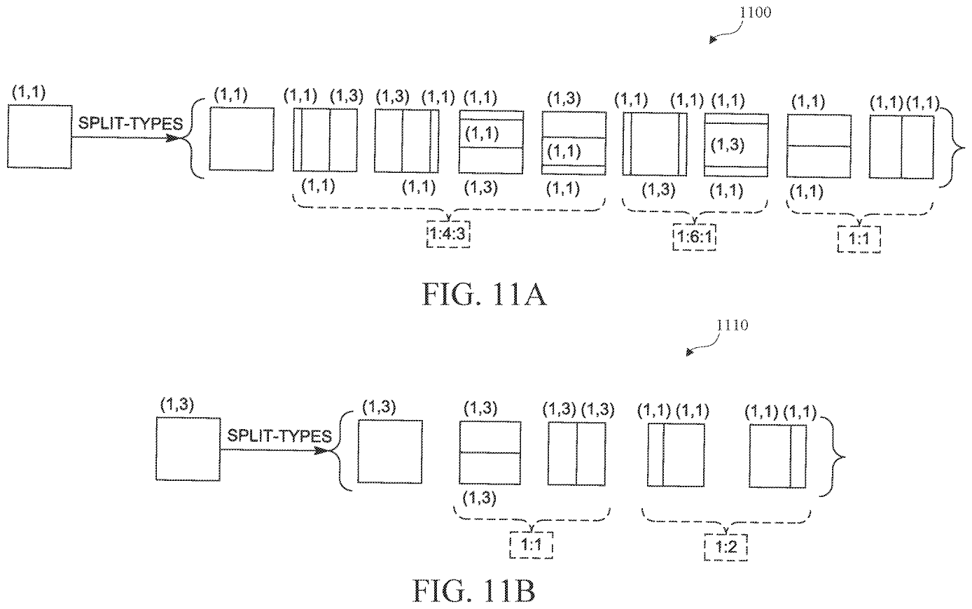

FIGS. 11A and 11B are diagrams of another multi-tree partitioning scheme using two categories in accordance with this disclosure. The first tree or category 1100 of the set of categories of the partitioning scheme comprises split-types for a block with dimensions defined by an unordered pair (1,1), and the second tree or category 1110 of the set comprises split-types for a block with dimensions defined by an unordered pair (1,3). Recall that (1,1) denotes a block that is power-of-two in both dimensions, and (1,3) denotes a block that is power-of-two in one dimension and 3 times a power of 2 in the other dimension.

Unlike the schemes previously described, binary and ternary splits may be used for the categories of this multi-partitioning scheme. This allows the partitioning scheme to do ⅛, ½, ⅜ ternary splits or ⅛, ⅜, ⅛ ternary splits of a side of power-of-two length to produce two blocks with dimensions defined by the unordered pair (1,1) and one block with dimensions defined by the unordered pair (1,3). Each sub-partition can be recursively split using the trees until a minimum block-size constraint is reached. For example, a split-type for a block that results in a sub-block having horizontal or vertical dimension of less than 4 pixels may not be used in the recursive partitioning.

The split-types for the first category 1100 of FIG. 11A include from left to right, a no split-type, four uneven unidirectional ternary split-types labeled 1:4:3, in particular two uneven vertical ternary split-types and two uneven horizontal ternary split-types, two uneven unidirectional ternary split-types labeled 1:6:1, in particular one uneven vertical ternary split-type and one uneven horizontal ternary split-type, and two even binary split-types labeled 1:1. The split-types for the second category 1110 of FIG. 11B include, from left to right, a no split-type, two even binary split-types labeled 1:1, and two uneven vertical binary split-types labeled 1:2.

As can be seen FIGS. 11A and 11B, the multi-tree partitioning scheme comprising the first category 1100 of FIG. 11A and the second category 1110 of FIG. 11B satisfies the conditions outlined above. Namely, the partition of every block that belongs to one of the categories 1100, 1110 of the multi-tree partitioning scheme results in sub-block(s) that each belong to one of the same categories 1100, 1110.

In general, decoding can include identifying a category of a multi-tree recursive partitioning scheme used for encoding a current block. Similarly, encoding can include identifying a category of a multi-tree recursive partitioning scheme used for encoding a current block. The multi-tree recursive partitioning scheme has multiple categories. In some implementations, each category has a set of block split-type options for a block size such that no sub-partition of a block within a category of the multiple categories produces a block size that is different from a category of the multiple categories. In some implementations, each category has a set of block split-type options for a block size such that no sub-partition of a block within a category of the multiple categories produces a block size that is different from a category of the multiple categories (that is, no resulting block size falls outside of the block sizes for the set of block split-type options for any category (tree) of a single multi-tree recursive partitioning scheme.

Decoding can also include decoding one or more sub-blocks of the current block determined using a split-type belonging to a category of the multi-tree recursive partitioning scheme that corresponds to the block dimensions. Encoding can also include encoding one or more sub-blocks of the current block resulting from partitioning the current block using a split-type option belonging to the category of the multi-tree recursive partitioning scheme.

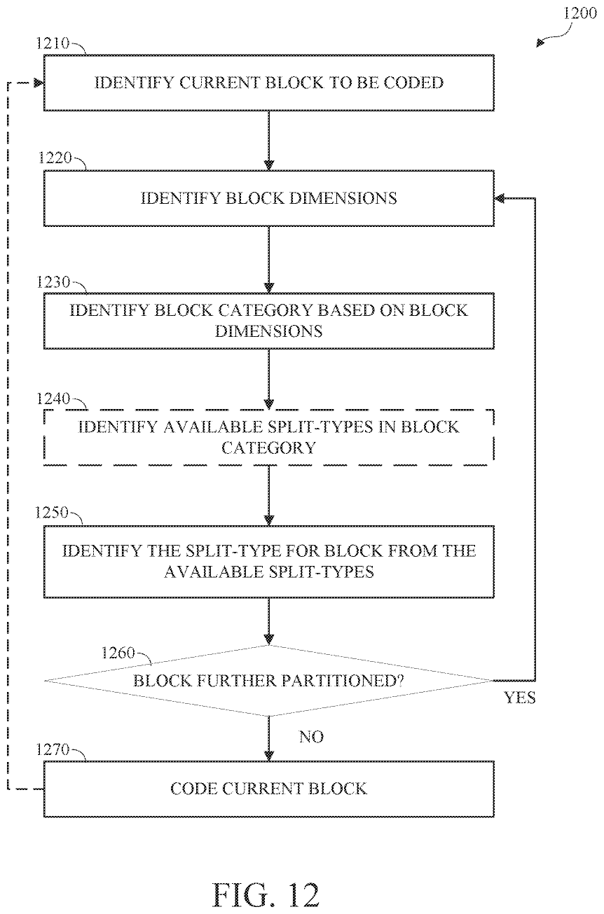

Further details are next explained with reference to FIG. 12, which is a flowchart diagram of an example of coding using a multi-tree recursive partitioning scheme in accordance with implementations of this disclosure. The terms coding and coded refer to both encoding and decoding unless otherwise noted or clear from context. Accordingly, some or all operations of FIG. 12 may be performed at an encoder, such as the encoder 400, or a decoder, such as the decoder 500, or both.

At operation 1210, an encoder identifies a coding unit/superblock (original or parent block) at operation 1210, also referred to as a current block to be encoded. For example, the size or pixel dimensions of each coding unit/superblock used to encode the frame may comprise 64×64 pixels or 128×128 pixels. The current block may be a CTU, for example. The encoder selects blocks in a coding order, such as raster scan order. The encoder can then identify which of the multi-tree recursive partitioning schemes to use. In general, the encoder, such as the encoder 400, would select the partitioning scheme (comprising multiple categories or trees) from any available multi-tree partitioning schemes including one or more of the partitioning schemes described herein. The partitioning scheme could be selected arbitrarily or could be selected as the best partitioning scheme according to the techniques described above with regards to FIG. 6, for example. Rate distortion optimization or other techniques may be used to determine the best partitioning scheme by selecting each of the available partitioning schemes, using that partitioning scheme to encode the current block, and then comparing the resulting encoded blocks for which partitioning scheme results in the encoded block with the highest quality with fewest bits. For the current block and current partitioning scheme, the operations 1200 include identifying block dimensions at operation 1220, identifying a block category based on the block dimensions at operation 1230, optionally identifying available split-types in the block category at operation 1240, identifying the split-type for the current block from the available split-types at operation 1250, and repeating the operations so long as there are sub-blocks available for further partitioning the current block in response to the query at operation 1260. Then, the current block is coded at operation 1270. These operations are described in more detail below with regards to the decoder operations.

Each sub-block has its size (or dimensions) considered to determine which block category and hence which split-type options (also referred to simply as split-types herein) are available for consideration in the recursive partitioning. Once fully partitioned, the current block is encoded (e.g., predicted, transformed, quantized, etc.) by encoding the one or more sub-blocks resulting from the partitioning, the selected encoded block (comprising the one or more sub-blocks) may be included in the encoded bitstream to represent the current block. Note that, as can be seen from this description and that of FIG. 6, the current partitioning scheme may result in more than one possible partitioning of the current block. If so, each of the partitioned current blocks may be compared to each other and/or to the one or more partitioned current blocks from other available partitioning schemes to determine the best block (e.g., the one that meets the conditions dictated by the encoder-whether fewest bits, highest quality, etc., or some combination thereof).

Although not shown in FIG. 12, the encoder can then signal a symbol (e.g., an index), also called an identifier, bit(s), etc., with the current block and/or any sub-blocks (such as in the block header) to indicate what split-type option was used for partitioning each of the blocks. For example, each split-type of the a category of the most efficient partitioning scheme (or a sub-set of those split-types based on availability) may have a unique index within the scheme that may be signaled. In some implementations, an index may not be transmitted. For example, a split-type may conform to a default split type such that the decoder knows to select the default split type when no index is received. In some implementations, the partitioning scheme selected for the current scheme may be signaled, such as using another symbol (or index, identifier, etc.) where more than one multi-tree partitioning scheme is available to blocks of an image or frame. This is not necessary, however. For example, a partitioning scheme may be signaled above the block level, such as in a frame header, such that the blocks are limited to one partitioning scheme.

The decoder starts with identifying, from an encoded bitstream, a coding unit/superblock (original or parent) at operation 1210, also referred to as a current block to be decoded. For example, the size or pixel dimensions of each coding unit/superblock used to encode the frame may comprise 64×64 pixels or 128×128 pixels. Although not shown in FIG. 12, the partitioning scheme of the multi-tree recursive partitioning scheme may be determined if there is more than one such partitioning scheme available to the block. For example, the decoder may decode bits from the encoded bitstream (an index, symbol, identifier, etc.) that identifies a partitioning scheme. Thereafter, each of the one or more sub-blocks is identified. The block dimensions for the current sub-block may be identified at operation 1220. Identifying the block dimensions can include identifying the values for the unordered pair (p,q) for the block size. The block category may be identified at operation 1230, which may be based on the block dimensions, specifically the unordered pair (p,q) in the examples described herein. In some implementations, the block category may be signaled by the encoder and decoded by the decoder, but this is less preferable.

Optionally, the available split-types are identified at operation 1240. In some implementations, fewer than all split-types of a category of the partitioning scheme may not be available. For example, some split-types may be excluded because of block size restrictions, e.g., one of the sub-partitions in the split-type may be an unsupported size (such as below a minimum size in one dimension). This step is optional because, knowing the size of the current sub-block, a no-split option may be inferred such that the decoder proceeds to the next sub-block. Identifying the split-type option at operation 1250 may include decoding a symbol (e.g., from the encoded bitstream from the block header) identifying a split-type option from the available split-type options of the category (tree).

Subsequently, each sub-partition in the chosen split-type (responsive to concluding that the block is further partitioned in response to the query at operation 1260) is processed recursively in depth-first order in the same manner, i.e., the (partition) block size is identified at operation 1220, the block category is identified at operation 1230, the available split-types are optionally identified at operation 1240 after eliminating invalid ones from the partitioning scheme, and the split-type option is identified at operation 1250 (e.g., by decoding a symbol indicating chosen split-type from the available split-type options of the category). If the no split split-type is signaled or chosen for a partition, then the recursive processing terminates. The decoder decodes other symbols indicating the prediction mode, motion vector(s) if any, coded prediction residues, etc., for each of the one or more sub-blocks so determined as described above with regards to the decoder 500. In this way, the current block is reconstructed as part of the coding at operation 1270. The decoding repeats for other blocks of an image or frame.

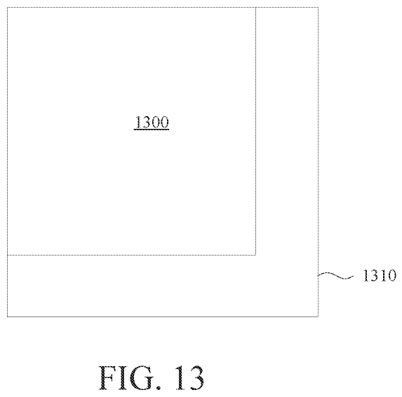

Note that because of the way the split-types are designed, for any parent power-of-two sized block, the end blocks may not have power-of-two dimension along each of the width and height of the block. That is, the block size p*2^{m}×q*2ⁿ may be such that one or both of p≠1 and q≠1. In such cases both prediction and transforms need to be conducted in non-power-of-two dimensions. In some embodiments, these block sizes could be natively supported for prediction. In some embodiments, these block sizes can be moved up to the nearest higher power-of-two block size for the purpose of the prediction operation in hardware or software by extending on the right and/or bottom, but only pixels that are in the block may be used by masking out the ones that are outside. Likewise for transforms, in some embodiments actual non-power-of-two transforms for the available categories can be used. In some other embodiments, the residue block can be filled up to the nearest higher power-of-two size by filling with so-called don't care pixels (value of 0 or any other selected by the encoder) on the right and/or bottom, followed by using conventional two-dimensional (2D) power-of-two transforms. The decoder can discard pixels outside the actual block after the inverse transform. This method is explained with reference to FIG. 13, where the actual block 1300 is expanded to the nearest larger power-of-two block 1310. The “don't care” region is located between the two blocks 1300, 1310. For prediction, the larger block may be used while discarding the samples (e.g., pixel values) in the “don't care” region. For transform, “don't care” region may be filled with “don't care” residue pixels (such as selected during encoder side optimization), and the larger transform may be used. The decoder can discard the “don't care” pixels after inverse transform.

In some other embodiments, the residue block can be further split into a set of sub-blocks (e.g., 2 sub-blocks). Only the sub-block(s) having a size equal to power-of-two is allowed to signal residual and the residual of the remaining sub-block(s) may be skipped.

According to the disclosure herein, improvements to compression efficiency may be achieved using a multi-tree partitioning scheme that provides flexible partitioning as compared to existing schemes.

As used herein, the terms “optimal”, “optimized”, “optimization”, or other forms thereof, are relative to a respective context and are not indicative of absolute theoretic optimization unless expressly specified herein.

The words “example” or “embodiment” are used herein to mean serving as an example, instance, implementation, or illustration. Any aspect or design described herein as using these terms is not necessarily to be construed as preferred or advantageous over other aspects or designs. Rather, use of the words is intended to present concepts in a concrete fashion. Relatedly, use of the term “an embodiment” or “one embodiment” or “an implementation” or “one implementation” throughout is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices described herein.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, one or more elements of the methods described herein may be omitted from implementations of methods in accordance with the disclosed subject matter.

The implementations of the transmitting computing and communication device 100A and/or the receiving computing and communication device 100B (and the algorithms, methods, instructions, etc. stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting computing and communication device 100A and the receiving computing and communication device 100B do not necessarily have to be implemented in the same manner.

Further, in one implementation, for example, the transmitting computing and communication device 100A or the receiving computing and communication device 100B can be implemented using a computer program that, when executed, carries out any of the respective methods, algorithms and/or instructions described herein. In addition, or alternatively, for example, a special purpose computer/processor can be utilized which can contain specialized hardware for carrying out any of the methods, algorithms, or instructions described herein.

The transmitting computing and communication device 100A and receiving computing and communication device 100B can, for example, be implemented on computers in a real-time video system. Alternatively, the transmitting computing and communication device 100A can be implemented on a server and the receiving computing and communication device 100B can be implemented on a device separate from the server, such as a hand-held communications device. In this instance, the transmitting computing and communication device 100A can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting computing and communication device 100A. Other suitable transmitting computing and communication device 100A and receiving computing and communication device 100B implementation schemes are available. For example, the receiving computing and communication device 100B can be a generally stationary personal computer rather than a portable communications device and/or a device including an encoder 400 may also include a decoder 500.

Further, all or a portion of implementations can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

It will be appreciated that aspects can be implemented in any convenient form. For example, aspects may be implemented by appropriate computer programs which may be carried on appropriate carrier media which may be tangible carrier media (e.g., disks) or intangible carrier media (e.g., communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

The above-described implementations have been described to allow easy understanding of the application are not limiting. On the contrary, the application covers various modifications and equivalent arrangements included within the scope of the appended claims, which scope is to be accorded the broadest interpretation to encompass all such modifications and equivalent structure as is permitted under the law.

1. A method, comprising:
identifying a category of a multi-tree recursive partitioning scheme used for encoding a current block, wherein the multi-tree recursive partitioning scheme comprises multiple categories, each category has a set of block split-type options such that each resultant sub-partition in each available block split-type option also belongs to one of the multiple categories, and the category corresponds to block dimensions of the current block; and
decoding one or more sub-blocks of the current block resulting from partitioning the current block using a split-type option belonging to the category of the multi-tree recursive partitioning scheme.

2. The method of claim 1, wherein each category of the multi-tree recursive partitioning scheme is defined by a unique, unordered pair (p, q) of block sizes p*2^{m}×q*2ⁿ, p and q are odd, positive integers, and m and n are positive integers.

3. The method of claim 2, wherein a first category of the multi-tree recursive partitioning scheme is defined by a first unordered pair (1,1), and a second category of the multi-tree recursive partitioning scheme is defined by a second unordered pair (1,3).

4. The method of claim 2, wherein a first category of the multi-tree recursive partitioning scheme is defined by a first unordered pair (1,1), a second category of the multi-tree recursive partitioning scheme is defined by a second unordered pair (1,3), and a third category of the multi-tree recursive partitioning scheme is defined by a third unordered pair (1,2).

5. The method of claim 2, wherein a first category of the multi-tree recursive partitioning scheme is defined by a first unordered pair (1,1), a second category of the multi-tree recursive partitioning scheme is defined by a second unordered pair (1,3), and a third category of the multi-tree recursive partitioning scheme is defined by a third unordered pair (1,5).

6. The method of claim 1, wherein the multi-tree recursive partitioning scheme comprises two categories, and each set of block split-type options includes at least four split-type options in addition to a no-split option.

7. The method of claim 1, wherein the multi-tree recursive partitioning scheme comprises three categories, and each set of block split-type options includes at least two split-type options in addition to a no-split option.

8. A method, comprising:
identifying a category of a multi-tree recursive partitioning scheme for encoding a current block, wherein the multi-tree recursive partitioning scheme comprises multiple categories, each category has a set of block split-type options such that each resultant sub-partition in each available block split-type option also belongs to one of the multiple categories, and the category corresponds to block dimensions of the current block; and
encoding one or more sub-blocks of the current block resulting from partitioning the current block using a split-type option belonging to the category of the multi-tree recursive partitioning scheme.

9. The method of claim 8, wherein each category of the multi-tree recursive partitioning scheme is defined by a unique, unordered pair (p, q) of block sizes p*2^{m}×q*2ⁿ, p and q are odd, positive integers, and m and n are positive integers.

10. The method of claim 8, wherein the multi-tree recursive partitioning scheme comprises only binary split-type options and ternary split-type options.

11. The method of claim 8, wherein the multi-tree recursive partitioning scheme comprises only binary split-type options in addition to a no-split option.

12. The method of claim 8, wherein the multi-tree recursive partitioning scheme comprises only quad split-type options in addition to a no-split option.

13. An apparatus, comprising:
a processor configured to perform the method according to claim 1.

14. An apparatus, comprising:
a processor; and
a memory storing instructions that, when executed, cause the processor to perform the method according to claim 8.

15. A non-transitory computer-readable storage medium storing an encoded bitstream, the encoded bitstream including the current block encoded according to the method of claim 8, and an identifier of the split-type option.

16. A non-transitory computer-readable storage medium storing an encoded bitstream, the encoded bitstream including a current block and an identifier of a split-type option, wherein the encoded bitstream is configured for decoding by a method comprising:
identifying a category of a multi-tree recursive partitioning scheme used for encoding the current block, wherein the multi-tree recursive partitioning scheme comprises multiple categories, each category has a set of block split-type options such that each resultant sub-partition in each available block split-type option also belongs to one of the multiple categories, and the category corresponds to block dimensions of the current block; and
decoding one or more sub-blocks of the current block resulting from partitioning the current block using the split-type option belonging to the category of the multi-tree recursive partitioning scheme.

17. The apparatus of claim 13, wherein each category of the multi-tree recursive partitioning scheme is defined by a unique, unordered pair (p, q) of block sizes p*2^{m}×q*2ⁿ, p and q are odd, positive integers, and m and n are positive integers.

18. The apparatus of claim 13, wherein a first category of the multi-tree recursive partitioning scheme is defined by a first unordered pair (1,1), and a second category of the multi-tree recursive partitioning scheme is defined by a second unordered pair (1,3).

19. The apparatus of claim 13, wherein the multi-tree recursive partitioning scheme comprises two categories, and each set of block split-type options includes at least four split-type options in addition to a no-split option.

20. The apparatus of claim 13, wherein the multi-tree recursive partitioning scheme comprises three categories, and each set of block split-type options includes at least two split-type options in addition to a no-split option.
